(19) United States
(12) Patent Application Publication
(10) Pub. No.: US 2025/0052227 A1
(43) Pub. Date: Feb. 13, 2025

(54) ENHANCED VERTICLE-AXIS WIND TURBINE

(71) Applicant: Kai Theodore Jasper Unwin-Wisnosky, Lancaster, PA (US)

(72) Inventor: Kai Theodore Jasper Unwin-Wisnosky, Lancaster, PA (US)

(21) Appl. No.: 18/595,848

(22) Filed: Mar. 5, 2024

Related U.S. Application Data
(60) Provisional application No. 63/519,269, filed on Aug. 13, 2023.

(51) Int. Cl. F03D 3/04; F03D 3/00

(52) U.S. Cl. CPC F03D 3/0472; F03D 3/009; F05B 2240/13; F05B 2240/213

(57) ABSTRACT

A vertical-axis wind turbine (VAWT), such as a Savonius-type VAWT, having one or more stages of curved blades rigidly mounted to a vertical axle and a structure rotatably mounted to the vertical axle. The structure has a deflector plate and a tail plate that orients the structure with respect to the blade-axle assembly such that the deflector plate is positioned upwind to deflect at least some of the wind away from the convex back faces of the curved blades, thereby increasing the force difference of the wind on the blades' concave front faces and convex back faces and therefore increasing the rotational force applied by the blades to the vertical axle. When connected to an electricity generator, the VAWT can generate electricity at a greater rate than analogous conventional VAWTs.

### CROSS-REFERENCE TO RELATED APPLICATIONS

This application claims the benefit of the filing date of U.S. provisional application No. 63/519,269, filed on Aug. 13, 2023, the teachings of which are incorporated herein by reference in their entirety.

### BACKGROUND

### Field of the Disclosure

The present disclosure relates to wind turbines and, more particularly but not exclusively, to Savonius-type vertical-axis wind turbines.

### Description of the Related Art

This section introduces aspects that may help facilitate a better understanding of the disclosure. Accordingly, the statements of this section are to be read in this light and are not to be understood as admissions about what is prior art or what is not prior art.

U.S. Patent Application Publication No. 2009/0146432 A1, U.S. Pat. No. 9,062,655 B2, and Taiwan Patent No. 201341653 A, the teachings of all of which are incorporated herein by reference in their entirety, teach Savonius-type vertical-axis wind turbines having curved blades with concave front faces that collect the force of the wind and convex back faces that deflect the force of the wind such that the turbine will rotate about its vertical axis in a particular direction, e.g., clockwise or counterclockwise depending on the configuration of the blades.

### SUMMARY

The present disclosure is directed to enhanced vertical-axis wind turbines having a structure with a deflector plate and a tail plate, where, in the presence of wind, the tail plate will orient the structure with the deflector plate at the upwind side of the turbine where the deflector plate deflects at least some of the wind away from the convex back faces of the turbine's curved blades, thereby increasing the rotational force and/or speed of the blades about the turbine's vertical axis and enabling, for example, more electricity to be generated by the turbine than similar turbines that do not have an analogous deflector-and-tail-plate structure.

The deflector-and-tail-plate structure increases the efficiency of the turbine by reducing the drag on the convex faces of the blades. Furthermore, turbine is capable of autonomous operation in real-world wind conditions, seamlessly adapting to rapidly changing wind directions. It achieves this through the deflector-and-tail-plate structure that rotates to align with the prevailing wind direction, thereby ensuring optimal positioning of the deflector plate to shield the convex faces of the blades at all times.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIGS. 1 and 2 are perspective side views of an enhanced, Savonius-type vertical-axis wind turbine (VAWT) according to certain embodiments of the present disclosure; and

FIG. 3 is a top view and FIG. 4 is a cross-sectional view of the VAWT of FIGS. 1 and 2.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

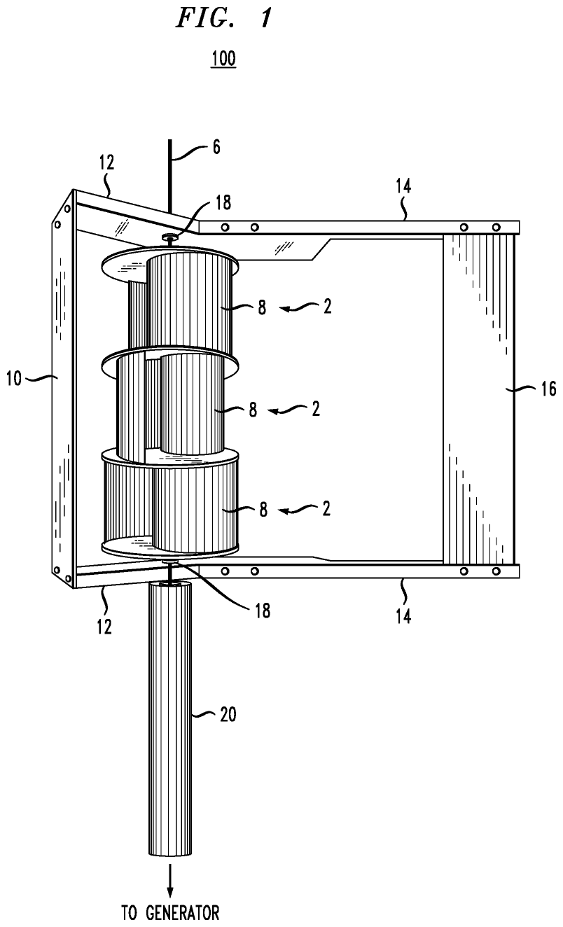

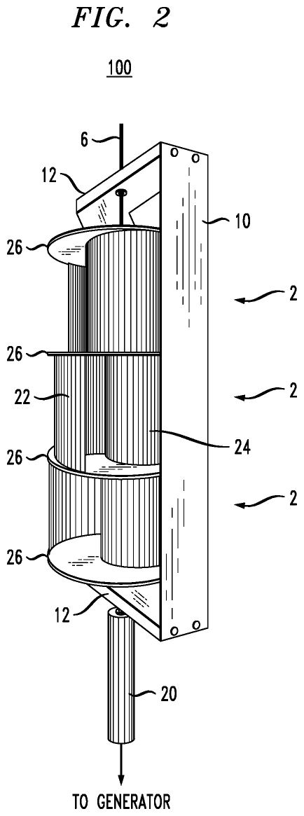

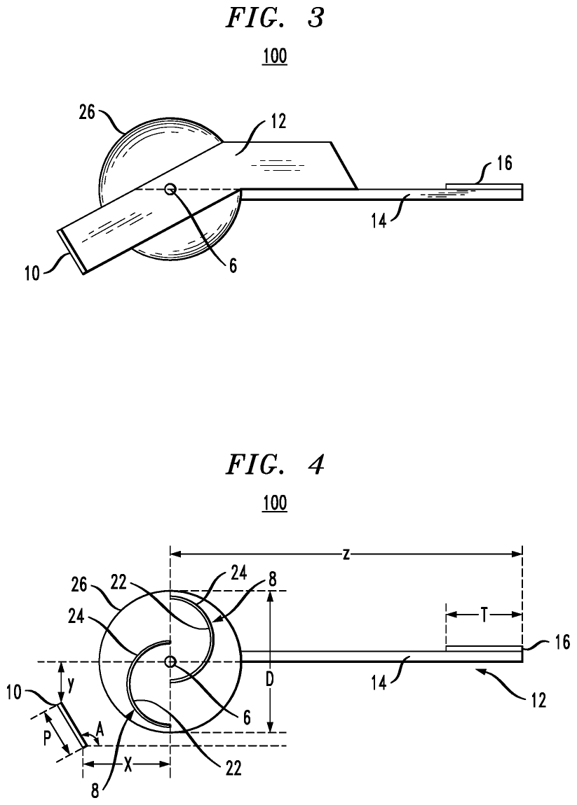

FIGS. 1 and 2 are perspective side views of an enhanced, Savonius-type vertical-axis wind turbine (VAWT) 100 according to certain embodiments of the present disclosure. FIG. 3 is a top view and FIG. 4 is a cross-sectional view of the VAWT 100 of FIGS. 1 and 2.

As shown in FIGS. 1 and 2, VAWT 100 has three blade stages 2 (i) surrounded and separated by four horizontal support plates 26 and (ii) rigidly mounted onto a vertical axle 6 that defines the VAWT's vertical axis about which the blades 8 and the vertical axle 6 rotate together. Although not shown in the figures, those skilled in the art will understand that the vertical axle 6 can be connected to drive other suitable hardware, such as (without limitation) an electricity generator or a pump for water or air.

As shown in FIGS. 2 and 4, each blade stage 2 has two curved blades 8, each of which has a concave front face 22 and a convex back face 24. Also coupled to the vertical axle 6 is a rigid structure 12 that comprises both the deflector plate 10 and the tail plate 16. The structure 12 is rotatably coupled to the vertical axle 6, for example, using top and bottom ball bearing assemblies 8, such that the structure 12 is able to rotate with respect to the vertical axle 6 about the vertical axis independent of the rotation of the blades 8 about the vertical axis, and vice versa.

As shown in FIGS. 1 and 2, the blade stages 2, which preferably have the same size, are angularly offset from one another, which increases the ability of the VAWT 100 to catch wind from any direction and start the VAWT 100 rotating.

As shown in FIGS. 3 and 4, the longitudinal axis of the vertical axle 6 is substantially co-planar with the planar surface defined by the tail plate 16, while the longitudinal axis of the vertical axle 6 is substantially skew with respect to the planar surface defined by the deflector plate 10. The relative sizes and orientations of the deflector plate 10 and the tail plate 16 are designed such that, in the presence of wind flowing in a particular direction from upwind to downwind, the tail plate 16 will cause the structure 12 to rotate such that (i) the tail plate 16 will point substantially in the downwind direction and (ii) as a result, the deflector plate 10 will be positioned on the upwind side of the VAWT 100 in front of the convex faces 24 of the blades 8 as they rotate around the vertical axis.

As shown in FIG. 4, the blades 8 of the VAWT 100 are configured such that the blades 8 will rotate clockwise in the view of FIG. 4 due to the concave and convex faces 22 and 24 of the blades 8. As also shown in FIG. 4, the structure 12 is designed such that, when the wind pushes the tail plate 16 to point in the downwind direction, the deflector plate 10 will be located upwind of the convex faces 24 of the blades 8 as they rotate around the vertical axis and oriented to deflect at least some of the wind away from the blades 8 before the wind reaches the blades' convex faces 24. This additional deflection of wind increases the difference in the force applied by the wind to the blades' concave faces 22 over the force applied by the wind to the blades' convex faces 24, thereby increasing the rotational force applied by the blades 8 to the vertical axle 6 and, depending on how the vertical axle 6 is further connected, the rotational speed of the vertical axle 6. When the vertical axle 6 is connected to an electricity generator (not shown), this increased force/speed can increase the rate at which electricity is generated by the VAWT/generator assembly.

Savonius-type VAWTs are drag based, meaning that they are pushed by the force of the wind directly, rather than by the lift force in lift-based turbines, such as horizontal-axis turbines. Because of this, one of the main limitations on efficiency of Savonius-type VAWTs is the drag on the backside of the returning blade creating resistance as it turns back into the wind. The deflector-and-tail-plate structure reduces this resistance, decreasing the force necessary to turn the turbine, improving efficiency (rotational speed and torque at a given wind speed). The deflector plate 10 sits upwind from the blades 8, in specific positioning embedded in the dimensions of the structure 12, that aligns the deflector plate 10 to shield the backsides 24 of the turbine blades 8 from oncoming wind. The structure 12 uses the tail plate 14, which is connected through support beams 14 to the deflector plate 10, to freely and autonomously rotate to operate effectively in changing wind directions. As the wind direction changes, because the structure 12 is attached to the axle 6 by ball bearings 18, the new force on the tail plate 14 rotates the structure 12. As a consequence of the optimal positioning being integrated within the structure 12, the deflector plate 10 effectively shields the backsides 24 of turbine blades 8 in all wind directions, thereby ensuring the realization of its full potential efficiency. In addition, the structure 12 is preferably designed to minimize the turbine wake's effect, which is the downwind disturbance caused by the turbine blades 8, on tail rotation.

Referring to FIG. 4, one possible implementation of the VAWT 100 of FIG. 1 has the following approximate dimensions:
D=178 mm
X=115 mm
Y=42 mm
A=101°
T=140 mm
Z=470 mm
P=55 mm

Those skilled in the art will understand how to design other suitable implementations having, for example, different phase-shift angles of the stages, different overlap ratios of the blades, and/or different height-to-diameter ratios. Different support mechanisms can be used for the axle such as a dual-support or dual-bearing system or a single-support or monopole system. Any suitable metal and/or plastic materials may be used for the different elements of the VAWT 100.

Although the disclosure has been described in the context of the Savonius-type VAWT 100 of FIGS. 1-4 having three stages 2 of two blades 8 each, those skilled in the art will understand that VAWTs of the present disclosure may have any suitable number of stages with any suitable number of blades in each stage. Those skilled in the art will also understand that the disclosure may be implemented in the context of VAWTs other than Savonius-type VAWTs.

In certain embodiments, the present disclosure is an apparatus having a VAWT comprising a vertical axle defining the VAWT's vertical axis; one or more stages of blades rigidly connected to the vertical axle, such that the vertical axle and the blades are able to rotate together about the vertical axis, wherein each stage has two or more blades and each blade has a concave front face and a convex back face; and a structure rotatably connected to the vertical axle, the structure having a tail plate and deflector plate configured such that, in the presence of wind blowing from an upwind direction to a downwind direction, the wind forces the structure to rotate with respect to the vertical axle such that the tail plate points substantially in the downwind direction and the deflector plate is upwind of the convex back faces of the blades as the blades rotate the vertical axle about the vertical axis.

In at least some of the above embodiments, the deflector plate is oriented to deflect at least some of the wind away from the convex back faces of the blades.

In at least some of the above embodiments, a longitudinal axis of the vertical axle is substantially co-planar with a planar surface defined by the tail plate, and the longitudinal axis of the vertical axle is substantially skew with respect to a planar surface defined by the deflector plate.

In at least some of the above embodiments, the VAWT is a Savonius-type VAWT.

In at least some of the above embodiments, the apparatus further comprises a generator or a pump connected to the vertical axle.

In at least some of the above embodiments, the VAWT has multiple blade stages, each blade stage having two blades.

In at least some of the above embodiments, the blade stages are angularly offset from one another.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

1. An apparatus having a vertical-axis wind turbine (VAWT) comprising:
a vertical axle defining the VAWT's vertical axis;
one or more stages of blades rigidly connected to the vertical axle, such that the vertical axle and the blades are able to rotate together about the vertical axis, wherein each stage has two or more blades and each blade has a concave front face and a convex back face; and
a structure rotatably connected to the vertical axle, the structure having a tail plate and deflector plate configured such that, in the presence of wind blowing from an upwind direction to a downwind direction, the wind forces the structure to rotate with respect to the vertical axle such that the tail plate points in the downwind direction and the deflector plate is upwind of the convex back faces of the blades as the blades rotate the vertical axle about the vertical axis, wherein:
the VAWT's vertical axis is parallel to and offset from a plane defined by a planar surface of the tail plate;
the VAWT's vertical axis is parallel to and offset from a plane defined by a planar surface of the deflector plate; and
all of the deflector plate is offset from the plane defined by the planar surface of the tail plate.

2. The apparatus of claim 1, wherein the deflector plate is oriented to deflect at least some of the wind away from the convex back faces of the blades.

3. (canceled)

4. The apparatus of claim 1, wherein the VAWT is a Savonius-type VAWT.

5. The apparatus of claim 1, further comprising a generator or a pump connected to the vertical axle.

6. The apparatus of claim 1, wherein:
the deflector plate is oriented to deflect at least some of the wind away from the convex back faces of the blades; and
the VAWT is a Savonius-type VAWT.

7. The apparatus of claim 6, further comprising a generator or a pump connected to the vertical axle.

8. The apparatus of claim 1, wherein the VAWT has multiple blade stages, each blade stage having two blades.

9. The apparatus of claim 8, wherein the blade stages are angularly offset from one another.

10. The apparatus of claim 1, wherein:
the deflector plate and the tail plate are interconnected by structure having a first pair of support beams interconnected with a second pair of support beams;
the first pair of support beams are connected to support the deflector plate;
the second pair of support beams are connected to support the tail plate; and
the first and second pairs of support beams are interconnected at an angle such that all of the deflector plate is offset from the plane defined by the planar surface of the tail plate.

11. The apparatus of claim 10, wherein the deflector plate is entirely flat.

12. The apparatus of claim 1, wherein the tail plate's area is more than 2.5 times the deflector plate's area.
